(19) United States
(12) Patent Application Publication
(10) Pub. No.: US 2017/0320593 A1
(43) Pub. Date: Nov. 9, 2017

(54) HELIPAD AND HELIPAD ILLUMINATION SYSTEM

(71) Applicant: Orga Holding B.V., Schiedam (NL)

(72) Inventors: Robert VAN BEEST, Schiedam (NL); Pieter Gerardus GOEDKNEGT, Schiedam (NL); Jan Willem DEÉ, Schiedam (NL)

(21) Appl. No.: 15/534,845

(22) PCT Filed: Dec. 11, 2015
(86) PCT No.: PCT/NL2015/050861

§ 371 Date: Jun. 9, 2017

(30) Foreign Application Priority Data
Dec. 12, 2014 (NL) 2013974

(51) Int. Cl. B64F 1/20; E01F 3/00

(52) U.S. Cl. CPC B64F 1/20; E01F 3/00

(57) ABSTRACT

Helipad and helipad illumination system The invention relates to a dynamic helipad illumination system (2) for dynamically illuminating a floor surface or supporting deck of helipad (1) at least partly in order to enable communication of information regarding one or more current local conditions of, at and/or near the helipad. The dynamic helipad illumination system comprises one or multiple illumination elements (3). The system is arranged to bring at least a part (2a) of said one or multiple illumination elements from a first illumination state, in which at least a part of the floor surface or support deck of the helipad is at least partly illuminated by at least a number of said at least part of the one or multiple illumination elements such that at least a part of the floor surface or support deck radiates a first visual appearance which may correspond to at least a first message to be communicated to a helicopter crew or a pilot, into a second illumination state, in which at least a part of the floor surface or support deck of the helipad is at least partly illuminated by at least a number of said at least part of the one or multiple illumination elements such that at least a part of the floor surface or support deck of the helipad radiates a second visual appearance which may correspond to at least a second message to be communicated to the helicopter crew or the pilot.

The invention relates to a helipad and to a helipad illumination system.

Generally, a helipad comprises a relatively flat, hard helicopter supporting deck or floor surface, located away from obstacles, on which a helicopter can land safely. Typically, the deck of the helipad is illuminated at least during, at least a part of, the night to facilitate safe landing of a helicopter. The deck or floor surface of the helipad usually comprises a central surface area called a touchdown and lift-off area (TLOF), which often has a circular or square shape. Said TLOF is normally encompassed by a so-called final approach and takeoff area (FATO), which for instance can have a circular, octagonal or square shape. The deck may further comprise an area forming a safety zone, which area encompasses the FATO.

Often, the helipad is marked, for example by means of a painted circle or painted square indicating the TLOF, which circle or square can for instance be yellow, green or white. Additionally or alternatively, the helipad can be marked by means of a painted ‘H’, which for example can be white and which often is located in the center of the TLOF. Other or alternative markings may be provided, such as for instance a FATO perimeter marking and/or a safety zone perimeter marking.

Helipads are usually provided with a helipad illumination system, such as for example in order facilitate helicopters to land during the night. The helipad can be illuminated at least partly by means of floodlights positioned at sides and/or corners of the helipad. Additionally, helipads are sometimes provided with lights mounted onto the helicopter deck and/or mounted flush with helicopter deck, such that that the visibleness of the helipad can be improved.

An object of the present invention is to provide an alternative helipad and/or an alternative helipad illumination system. In particular, it can be an object of the invention to provide a helipad and/or a helipad illumination system, wherein at least one disadvantages of prior art helipads and/or prior art helipad illumination systems is counteracted. More in particular, the invention may aim to provide a helipad and/or a helipad illumination system which can facilitate landing onto a helipad and/or taking off from said helipad in a relatively safe and/or relatively simple manner.

Thereto, an aspect of the invention provides for a dynamic helipad illumination system for dynamically illuminating a floor surface or supporting deck of a helipad at least partly in order to enable communication of information regarding one or more current local conditions of, at and/or near the helipad, the dynamic helipad illumination system comprising one or multiple illumination elements, wherein the system is arranged to bring at least a part of said one or multiple illumination elements from a first illumination state, in which at least a first part of the floor surface or support deck of the helipad is at least partly illuminated by at least a number of said at least part of the one or multiple illumination elements such that said at least part of the floor surface or support deck radiates a first visual appearance which may correspond to at least a first message to be communicated to a helicopter crew or a pilot, into a second illumination state, in which at least a second part of the floor surface or support deck of the helipad is at least partly illuminated by at least a number of said at least part of the one or multiple illumination elements such that said second part of the floor surface or support deck of the helipad radiates a second visual appearance which may correspond to at least a second message to be communicated to the helicopter crew or the pilot, wherein said first visual appearance differs from said second visual appearance. It is noted that the first part of the floor surface or support deck and the second part of the floor surface or support deck may be formed by two different area portions of the floor surface or support deck. However, said first and second part may preferably overlap partly, more preferably may overlap substantially completely. Said first and second part may for instance thus be formed by single area portion of the helipad floor surface or support deck.

By arranging the illumination system such that it can illuminate the floor surface or support deck of the helipad in different manners, i.e. that the helipad illumination system can be switched from radiating a first visual appearance which can correspond to at least a first message to radiating another visual appearance which can correspond to at least an alternative message, the helipad illumination can be used to communicate dynamic information, for example relating to a current status of the helipad or relating to a prevailing weather condition, especially one or more conditions of the wind, to a pilot or a helicopter crew. It is noted that the messages can thus be communicated by means of the dynamically illuminated floor surface or support deck of the helipad. This can be highly advantageous, for instance because a pilot may observe at a glance the information communicated to him by means of the illumination system. It is noted that the pilot does thus not even need to take his eyes of the floor or the deck of the helipad in order to check the respective information about the helipad or the helipad surroundings. Moreover, by arranging the illumination system to bring at least a part of the one or multiple illumination elements from a first illumination state into a second illumination state, the information presented can be switched. As a result of this dynamic illumination, the helipad can facilitate continually irradiating the latest information available, such as for instance the freshest data regarding the wind speed and/or wind direction. Since such dynamic information can be presented conveniently on the deck or floor of the helipad, the illumination system can counteract that a change of a certain variable is unnoticed by a pilot, which can contribute to relatively safe helipad. Furthermore, the latest information presented by the helipad illumination system can be kept constantly visible on the deck, such that even in case the pilot unfortunately forgets the latest information provided to him, he can reacquire said information, especially he can reacquire said information in a simple and safe manner, without even needing to take his eyes off the helipad deck or floor. Moreover, the information displayed by the deck or floor surface can be visible at a relatively great distance, e.g. from a relatively large height. Since the dynamically illuminated helipad support deck or floor surface will advantageously extend substantially horizontally, information regarding current local conditions, e.g. wind conditions, can be observed from above relatively well, also from a relatively high altitude.

By arranging multiple illumination elements of the illumination system such that they can together form an array or a matrix in or on the support deck or floor surface of the helipad, e.g. wherein said illumination elements form pixels thereof, a relatively advanced message can be communicated in a relatively simple manner via said deck or floor. The array or matrix may then form a raster image, in which the pixels are arranged in a two-dimensional grid. Said array or matrix may function as a monitor, picture screen or so-called visual display unit (VDU), such that said array or matrix may for instance display images, e.g. including arrows, pictures, letters, numbers etc., which are build up from multiple pixels.

Advantageously, illumination elements forming pixels in the array or the matrix, can be formed as a light emitting element, especially LED's, protected by a cover. Each cover, which preferably may be arranged for substantially evenly distributing light from the light emitting element(s) it covers, may form a separate pixel in the matrix or array. The cover, which may be formed from a transparent or translucent material or from a transparent or translucent composition, such as from a glass/plastic laminate and/or from safety glass, may have a surface or a layer arranged for substantially evenly distributing light. Said layer or surface may for instance be frosted or matted, and/or may be provided with a certain coating, e.g. a fluorescent coating.

Additionally or alternatively, the cover may be a substantially dome-shaped cover. The dome shape may facilitate that the cover can be relatively strong or robust, which is advantageous when it is mounted on top of the helipad deck or floor. It will be appreciated that the cover, especially a cover dome, can be of such design that it for instance can withstand the pressure and forces applied thereon by a helicopter, or the like, e.g. when it lands at least partly on said cover.

Additionally or alternatively, the substantially dome-shaped covers may facilitate that the dynamically illumination system can be used in potential hazardous environments and/or that said system can be substantially explosion-proof.

Another advantage of a substantially dome-shaped cover mounted on the deck or floor may lie in that the lightened cover can be seen from aside. Hence, information provided by the matrix or array may be also be visible relatively well obliquely from above, e.g. when a helicopter is approaching the helipad.

It is noted that the pixels, especially pixels formed by covers, more in particular substantially dome-shaped covers, may be have a substantially round shape when seen from above. However, in alternative embodiments, they may have different shapes, e.g. they may be substantially square, rectangular, oblong, and/or elliptical shaped. Seen from above, the pixels or covers may have a width and/or a length, and/or a diameter, in the range of 2 cm-50 cm, preferably between 3 cm and 25 cm, such as between 5 cm and 15 cm. For example, the width, length, and/or diameter can be about 6, 7, 8, 9, 10, 11 or 12 cm. It will be appreciated that multiple ones of the, especially all of the, pixels and/or covers may have substantially the same dimensions, such as substantially the same width, length, and/or diameter. Multiple illumination elements forming pixels in the array or the matrix may have, when seen from above, a surface area between 15 cm² and 200 cm², e.g. a surface area of at least 20, 25, 30, 40 or 50 cm² and/or of at most 180, 150, 120, 100, 80, 60 or 50 cm².

Advantageously, the pixels and/or covers can be located relatively close to each other in order to provide a matrix or array that can provide information that is legible relatively well. For example, the distance between the facing edges of two adjacent pixels and/or covers can be at most three times larger than the width, length, and/or diameter of said pixels and/or covers. Preferably, a ratio between the length of an interspace between two adjacent pixels and/or covers, and the width, length, and/or diameter of said pixels and/or covers is at most 2:1, 1:1, 1:2, 1:3 or 1:4. Actually, the length of said interspace may be even smaller.

In preferred embodiments, the array or matrix can be part of the floor surface or support deck of the helipad. Although, the illumination system, illumination elements, pixels and/or covers can be countersunk, completely or partly, into the helipad deck or floor, it is noted that the illumination system, illumination elements, pixels, covers and/or domes, which each can form part of the floor or deck once installed, may advantageously be mounted on top of a top surface of the deck or floor of the helipad. Hence, information provided by the matrix or array may also be visible relatively well obliquely from above, e.g. when a helicopter is approaching the helipad. Advantages may lie in that the system, illumination elements, pixels, covers and/or domes may be installed relatively easily, e.g. in order to adjust or upgrade an existing helipad, and/or may be removed and/or replaced relatively easily. An advantage of not countersinking the system, illumination elements, pixels, covers and/or domes may be that the accumulation of dirt in cavities above countersunk parts can be counteracted. Additionally or alternatively, information provided by the dynamically illumination system may be visible relatively well from aside and/or obliquely from above, e.g. when a helicopter is approaching the helipad.

Since the illumination is dynamic, the image displayed may for instance be replaced by another image if the information to be communicated by said first image needs to be replaced. It is noted that the dynamic system may be arranged to display different static images. For example, a first substantially static image can be replaced by a second substantially static image. However, in embodiments, the illumination system may additionally or alternatively be arranged to display moving images.

In embodiments, at least one illumination element can be formed such that itself can form an illuminated sign, and/or at least one group of illumination elements is formed such that the illumination elements of said group can together form a sign, e.g. a letter, number, cross, arrow, et cetera. For example, seven, fourteen or sixteen elongated illumination elements may together form a seven-segment display (SSD), a fourteen-segment display (FSD), or a sixteen-segment display (SISD), e.g. for displaying letters and/or numerals, such as for instance numerical information, such as information regarding a measure of wind speed or wind-force, e.g. expressed in the Beaufort scale.

The invention also relates to a helipad comprising a dynamic helipad illumination system.

Furthermore, the invention relates to a use of a dynamic helipad illumination system during landing or taking off.

Advantageous embodiments according to the invention are described in the appended claims.

By way of non-limiting examples only, embodiments of the present invention will now be described with reference to the accompanying figures in which:

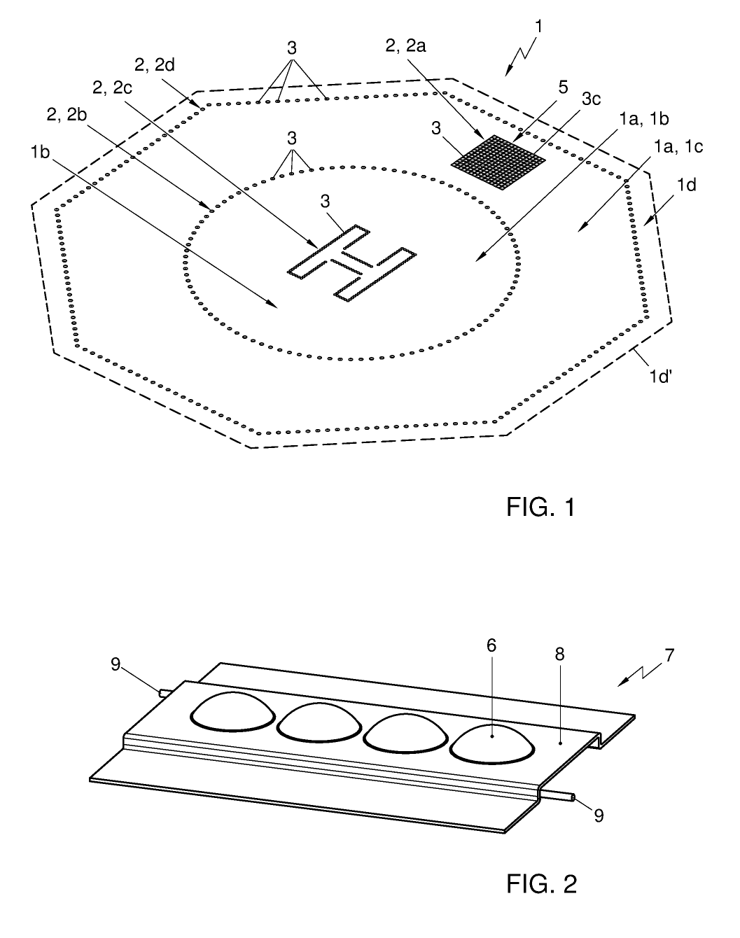

FIG. 1 shows a schematic perspective view of an exemplary embodiment of a helipad provided with an exemplary embodiment of a dynamic helipad illumination system according to an aspect of the invention;

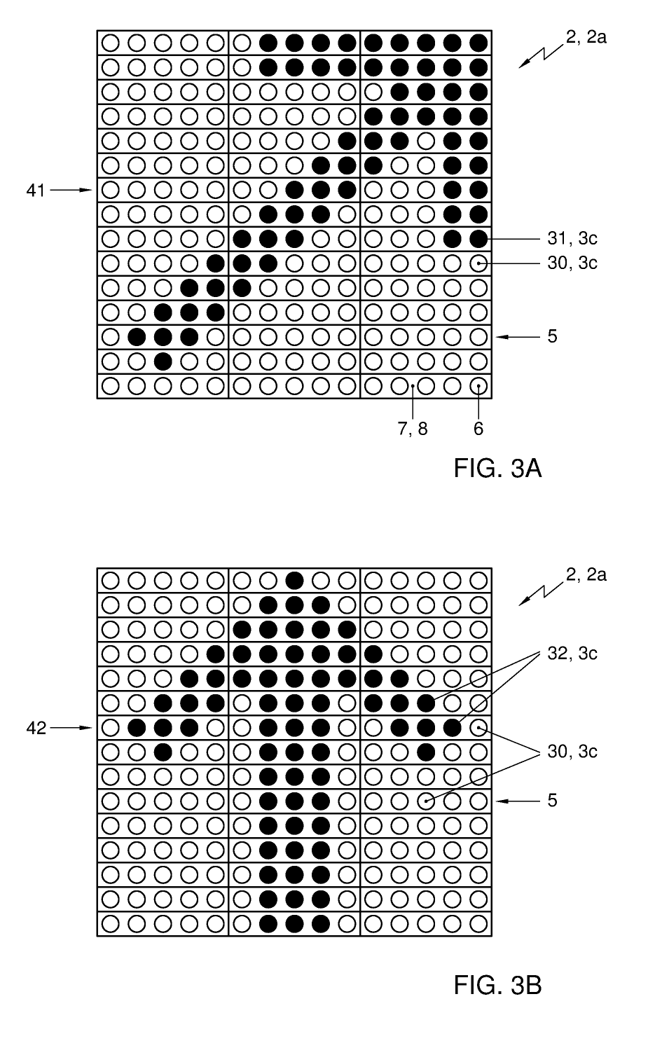

FIG. 2 shows a schematic perspective view of an exemplary embodiment of an illumination unit for a dynamic helipad illumination system;

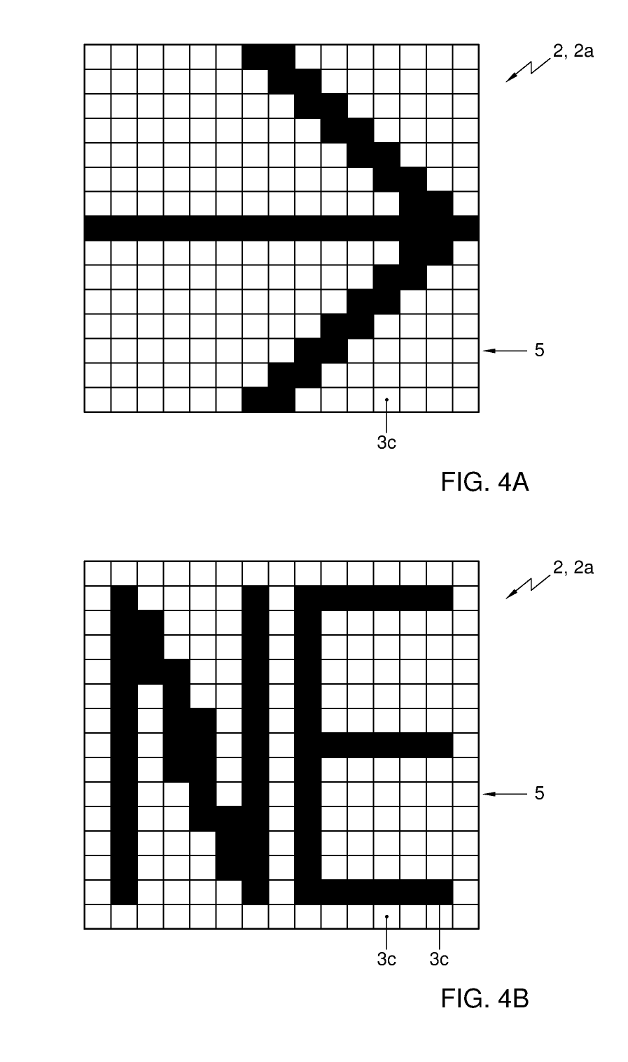

FIG. 3a shows a schematic top view of an exemplary embodiment of a dynamic helipad illumination system in a first illumination state;

FIG. 3b shows the dynamic helipad illumination system of FIG. 3a in a second illumination state; and

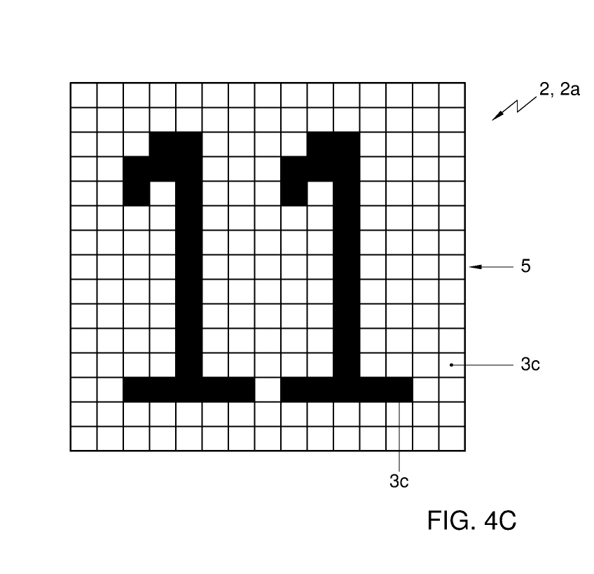

FIGS. 4a-4c show schematic top views of an alternative embodiment of an illumination system in three different illumination states.

It is noted that the figures show merely preferred embodiments according to the invention that are given by way of non-limitative examples. In the figures, the same or similar reference signs or numbers refer to equal or corresponding parts.

FIG. 1 shows a schematic perspective view of an exemplary helipad 1 provided with an exemplary embodiment of a dynamic helipad illumination system 2 according to an aspect of the invention. The dynamic helipad illumination system 2 is for dynamically illuminating a helipad 1 at least partly in order to enable communication of information regarding one or more current local conditions of, at and/or near said helipad 1.

Here, the dynamic helipad illumination system 2 can comprise multiple illumination elements 3, each of which for instance may comprise and/or may be formed by a light emitting element, such as a lamp, or another light source. The illumination elements 3, and/or its light emitting element, can for example be or comprise an incandescent lamp, a LED or LED lamp, an Arc Lamp, or a gas-discharge lamp. The system 2 can be arranged to bring at least a part 2a of said multiple illumination elements 3 from a first illumination state, in which at a part of a floor surface 1a or support deck 1a of the helipad 1 is at least partly illuminated by at least a number 3a of said at least part 2a of the multiple illumination elements 3 such that at least a part 2a of the floor surface or support deck 1a radiates a first visual appearance 41 which may correspond to at least a first message to be communicated to a helicopter crew or a pilot, into a second illumination state, in which at least a part 2a of the floor surface or support deck 1a of the helipad 1 is at least partly illuminated by at least a number of said at least part 2a of the multiple illumination elements 3 such that at least a part 2a of the floor surface or support deck of the helipad 1 radiates a second visual appearance 42 which may correspond to at least a second message to be communicated to the helicopter crew or the pilot.

However, in alternative embodiments, the system 2 may comprise one illumination element, e.g. comprising a light source of which the color and/or intensity of emitted thereby can be changed and/or a light source which can be controlled such as to lighten up partly. The system 2 can be arranged to bring at least a part of said element from a first illumination state, in which at least part of said one illumination element 3 at least partly illuminates the helipad 1 and radiates a first visual appearance, which may correspond to at least a first message to be communicated to a helicopter crew or a pilot, into a second illumination state, in which said one illumination element at least partly illuminates the helipad and radiates a second visual appearance, which may correspond to at least a second message to be communicated to the helicopter crew or the pilot.

It is noted that said first visual appearance 41 differs from said second visual appearance 42, e.g. in color and/or light intensity. However, in preferred embodiments, the visual appearances 41, 42 may alternatively or additionally differ in size, in shape and/or in image displayed. Alternatively or additionally, said first appearance 41 can differ from the second visual appearance 42 in that at least a part of said one illumination element 3 and or at least a part of said multiple illumination elements 3 flickers or blinks in a first state in which it radiates one visual appearance, e.g. the first appearance, and flickers or blinks at a different rate and/or intensity in a second state in which it radiates another visual appearance, e.g. the second appearance, or does not flicker or blink in said second state, but radiates light in a substantially invariable or constant manner then.

It is noted that, in preferred embodiments, an illumination state, e.g. the first illumination state, the second illumination state, or a further illumination state, can be a state in which at least a part 2a of the respective illumination element 3 or elements 3 displays a substantially static image, e.g. an image comprising one or multiple arrows, crosses, circles, words, letters, numbers, and/or pictograms, etc., see e.g. FIGS. 3a-4c. However, within an illumination state, at least a part of the respective illumination element(s) 3 at least partly illuminating the floor surface 1a or supporting deck 1a of the helipad 1 and radiating a respective visual appearance 41, 42 may alternatively display a substantially and/or partly dynamic image, e.g. an image of which at least a part flashes, flickers, blinks or changes color, preferably relatively rapidly, for instance to communicate a warning signal and/or to draw attention to a certain part of the illumination system, especially a part displaying relatively important information, such as for instance information regarding a recently changed condition of, at and/or near the helipad 1. For example, when a wind direction or wind force changed relatively much and/or when the overall conditions rapidly changed from relatively safe to harsh conditions, an image or image portion displaying said new conditions, e.g. numerals displaying a new wind force, can be highlighted by means of letting said image or image portion, e.g. numerals, flicker at least partly and/or by letting illumination elements 3 or pixels located near and/or around said image or image portion flicker.

The first message, the second message and/or a further message to be communicated to a helicopter crew or a pilot, e.g. a drone or helicopter pilot, can comprise information being convenient, useful and/or even necessary for said pilot, e.g. in order to enable him to land an aircraft, e.g. a helicopter, relatively safely. For example, the respective message can comprise information relating to the wind, such as for instance including a wind direction (see e.g. FIGS. 3a-4b) and/or a wind speed (see e.g. FIG. 4c).

Alternatively or additionally, a message may comprise information about a current state or status of the helipad 1, e.g. whether the helipad 1 is reserved for another helicopter or is released and that the pilot may land his helicopter on said helipad 1. Additionally or alternatively, said or another message may comprise information about certain specifications, e.g. sizes and/or dimensions, of the helipad 1, such as a maximum weight to be supported by said helipad 1 and/or a maximum size (e.g. a maximum length and/or a maximum main rotor diameter) of a helicopter permitted to land on said helipad 1. Alternatively or additionally, a message can provide other information, e.g. warnings, for instance in relation to limited visibility, wind gusts, and/or the helipad 1 being out of order temporarily.

With respect to the helipad 1, it is noted that in this disclosure, the term helipad can be understood as at least including facilities including a relatively flat, hard supporting deck 1a or floor surface 1a for supporting an aircraft that can land and/or take-off at least in a substantially vertical manner. Such aircraft may for instance be a helicopter and/or a so-called vertical take-off and landing (VTOL) aircraft. It will be appreciated that the deck or floor surface 1a, which may be substantially flat and/or extend in substantially flat plane, may extend substantially horizontally. Said supporting deck 1a or floor surface 1a, on which a helicopter or VTOL aircraft can land, can be located away from obstacles, in order to facilitate a safe landing. Although the respective aircraft, e.g. the helicopter, may be a manned aircraft, it may alternatively be formed by an unmanned aerial vehicle (UAV) or a drone, e.g. a remote-controlled helicopter. The pilot controlling the aircraft may for example be a pilot manning a helicopter or a pilot remote-controlling a drone or a remote-controlled helicopter.

The helipad deck 1a can be illuminated at least partly and/or at least temporarily, e.g. at least during at least a portion of the night and/or by implementing the helipad illumination system 2 as a pilot-controlled lighting system, which may enable illuminating the helipad deck 1a only when an aircraft is to land or take off.

In preferred embodiments, the deck 1a or floor surface 1a of the helipad 1 may comprise a central surface area 1b called a touchdown and lift-off area (TLOF) 1b, which for instance can have a circular or square shape. Said TLOF can preferably be encompassed by a so-called final approach and takeoff area (FATO) 1c, which for instance can have a circular, octagonal or rectangular, e.g. square, shape. Said FATO can for instance have a width, length and/or diameter between 15 and 40 m. For example, said width, length and/or diameter can be at least 18, 20, 22 or 15 meter and/or can be at most 35, 30 or 25 meter. The deck 1a may further comprise an area 1d forming a safety zone 1d, which area 1d can encompass the FATO 1c.

The helipad 1 can be marked by means of a colored, e.g. painted, field or by means of a colored, e.g. painted, border, such as a circle or square, indicating the TLOF 1b, which field or border can for instance be yellow, green or white. Additionally or alternatively, the helipad 1 can be marked by means of a colored, e.g. painted, ‘H’, which for example can be white and which for instance can be located in the TLOF 1b, preferably in a center thereof. Other or alternative colored, e.g. painted, markings may be provided, such as for instance a colored FATO field, a FATO perimeter marking, a colored safety zone field and/or a safety zone perimeter marking 1d′.

It is noted that the TLOF, 1b the ‘H’, the FATO 1c and/or the safety zone 1d may additionally or alternatively be marked by means of illumination, e.g. illumination in one or more specific colors. For example, one or multiple parts of the helipad 1 can be illuminated and/or marked by means of one or more respective parts, e.g. one or more respective illumination elements 3, of the dynamic helipad illumination system 2.

At least a part 2d of the illumination elements 3 of the dynamic helipad illumination system 2 may be arranged to form a FATO indication illumination 2d for marking the final approach and takeoff area (FATO) 1c, e.g. formed as a FATO perimeter indication illumination 2d for marking a perimeter of the FATO 1c. It is noted that the FATO perimeter indication illumination 2d may for instance be formed as an indication line 2d, preferably a line having a substantially octagonal shape 2d, a substantially circular shape or a substantially rectangular shape, especially a substantially square shape. Said indication line illumination 2d may for instance be formed as an illuminated interrupted or dotted line, but may alternatively be formed as a substantially uninterrupted illuminated line 2d.

Additionally or alternatively, at least a part 2b of the illumination elements 3 of the dynamic helipad illumination system 2 may be arranged to form a TLOF indication illumination 2b for marking the touchdown and lift-off area (TLOF) 1b, e.g. formed as a TLOF perimeter indication illumination 2b for marking a perimeter of the TLOF 1b. However, said TLOF indication illumination 2b may mark said TLOF 1b in another manner, e.g. by illuminating a relatively large field of the TLOF 1b or by illuminating substantially the complete surface area covered of said TLOF 1b.

The TLOF perimeter indication illumination 2b can be enclosed by the FATO perimeter indication illumination 2d and can preferably be centered in the FATO 1c. The TLOF perimeter indication illumination 2b may for instance be formed as an illuminated indication line, preferably having a substantially rectangular, especially square, or circular shape. However, said TLOF perimeter indication line illumination may have any other suitable shape and can for instance be formed as an illuminated outline of a ‘+’ or ‘X’ shape, e.g. in case of a hospital helipad. Further, it is noted that said TLOF perimeter indication line illumination 2b may for instance be formed as an illuminated interrupted or dotted line, but may alternatively be formed as an illuminated uninterrupted line.

Additionally or alternatively, at least a part 2c of the illumination elements 3 of the dynamic helipad illumination system 2 may be arranged to form an ‘H’ shaped illumination 2c, preferably an ‘H’ enclosed by said TLOF indication illumination 2b. Although in embodiments, as can be seen in the exemplary embodiment shown in FIG. 1, respective illumination elements 3 can form an outline of an ‘H’, respective illumination elements 3 may in alternative embodiments cover substantially the whole surface area covered by the ‘H’, e.g. the surface area enclosed by said outline may be filled with illumination elements 3.

It is noted that the TLOF indication illumination 2b, the ‘H’ shaped illumination 2c, and/or the FATO indication illumination 2d can be formed as one or more static parts of the dynamic illumination system 2. This means that said respective part(s) can be illuminated substantially invariably, and that another part of the helipad 1 may be illuminated in a variable or changeable manner in order to facilitate communication of information regarding one or more current local conditions of, at and/or near the helipad.

At least a part 2a of the illumination elements can be arranged to form an illumination portion for at least partly illuminating another part of the helipad 1 than the parts to be illuminated by the TLOF indication illumination 2b, especially formed by a TLOF perimeter indication illumination, the ‘H’ shaped illumination 2c or the FATO indication illumination 2d, especially formed by a FATO perimeter indication illumination. In embodiments, such as for instance the exemplary embodiment of FIG. 1, such part 2a of the illumination elements 3 can be arranged to form an illumination portion 2a for illuminating at least partly a part of the helipad which is located at least partly between the TLOF perimeter indication illumination 2b and the FATO perimeter indication illumination 2d. Additionally or alternatively, said at least a part 2a of the illumination elements 3 can be arranged to be switched between two or more different illumination states.

Advantageously, at least a number of the illumination elements 3, e.g. at least a part of at least one array 5 or matrix 5 of illumination elements, can be located outside the TLOF 1b, preferably outside the TLOF 1b and within the FATO 1c.

By locating at least a part of the one or multiple illumination elements 3 arranged to irradiate different visual appearances, at least partly outside of the TLOF 1b, it can be facilitated that a pilot or crew, especially in case of a manned helicopter or VTOL aircraft, can have a view on said part 2a of the illumination elements 3.

However, the array 5 may be placed at another place. For example, the array or matrix 5 may be placed within the TLOF 1b, which can for instance be advantageous, e.g. because a pilot can be focusing on said TLOF forming a target area during the landing proceedings.

Although the array or matrix 5, which can be for communicating information regarding one or more current local conditions of, at and/or near the helipad, may in embodiments cover only and/or at least a certain part of the total surface area of the helipad deck 1a, a certain part of the total FATO surface area, and/or a certain part of the total TLOF surface area, it is noted that the array 5 or matrix 5 may in alternative embodiments cover substantially the whole surface area of the TLOF, FATO, and/or helipad deck 1a. It is further noted that, at least a part of, the illumination elements 3 may be formed by elements 3 mounted on the helipad deck 1a or floor 1a. The elements mounted on the deck can be positioned on top of the deck, and may for example lay on top of the deck, preferably in a manner in which they are fixedly attached to the deck. However, in embodiments, at least a part of the illumination elements 3 may be countersunk, completely or partly, in the helipad deck 1a or floor and/or may be provided below a transparent or translucent floor portion. Advantageously, the countersunk illumination elements or their covers 6 may be substantially flush with the deck or floor surface of the helipad, which may counteract that dirt will accumulate on top of the illumination element or cover.

As mentioned above, in advantageous embodiments, multiple illumination elements 3 of the system 2 may together form an array 5 or a matrix 5, which is suitable for displaying information regarding one or more current local conditions of, at and/or near the helipad 1. For example, a multiple number of the illumination elements 3 can form pixels in the array or the matrix 5, preferably pixels being switchable and/or controllable independently of each other. Preferably, a single illumination element 3 may form a single pixel. The array or matrix 5 may form a raster image, in which the pixels are arranged in a two-dimensional grid.

Advantageously, a pixel can have at least two different states, e.g. an on-state, i.e. in which the pixel is radiation light, and an off-state, in which the pixel can be dark. Alternatively or additionally, the color and/or the light intensity of the light emitted by the pixel can be altered when the pixel is brought from one state to another state. The pixel may for example be switchable between two or more different states. For example, the pixel may be arranged to emit light of a certain color in a first state and light of a different color in a second state.

In embodiments, one or multiple illumination elements 3, especially illumination elements 3c forming pixels in the array 5 or the matrix 5, can be formed as comprising a light emitting element 3, preferably a LED, and a cover 6, e.g. a dome 6, protecting said light emitting element 3. Said dome or cover 6 can be transparent and/or translucent to allow light rays of the light emitting element to pass through said cover or dome 6.

A dome 6 can for instance represent a pixel in the array 5. In embodiments, a dome and its respective light emitting element can form a pixel. However, in alternative embodiments, multiple light emitting elements can be located below a single dome, and can together with said dome 6 form a single pixel. For instance, the multiple light emitting elements located below a single dome can be arranged to emit different colors of light, e.g. different LEDs can be provided below a dome which each can emit a different color such that the color of light emitted by said respective pixel can be changed.

FIG. 2 shows a schematic perspective view of an exemplary embodiment of an illumination unit 7 for a dynamic helipad illumination system 2. The illumination unit 7 may for instance comprise a cover unit 8 in which one or more of the domes 6 or light emitting element covers 6 are provided and which cover unit 8 covers at least a part of cabling 9, e.g. cabling for providing electricity to the light emitting elements and/or for controlling said light emitting elements and/or said pixels or light emitting elements 3. Although the exemplary embodiment of the illumination unit 7 shown in FIG. 2 is there formed as a straight, elongated unit 7, which for instance can be used to form a part of an outline of the ‘H’ shaped illumination 2c on the helipad deck 1a or a part of a TLOF or FATO perimeter indication illumination 2b, 2d or a part of an array 5 or matrix 5 such as shown in FIGS. 3a and 3b, the illumination unit 7 may alternatively be of different design. For example, said illumination unit 7 can have a bended or curved shape, e.g. to form a part of a round TLOF perimeter indication illumination 2b, or said illumination unit 7 can form a two-dimensional raster, e.g. having a width being substantially equal to its length, for instance in order to provide for a sub-matrix in the matrix 5.

Although here above embodiments of the dynamic helipad illumination system 2 are described in which a matrix 5 is formed by at least a part of its illumination elements, the invention also relates to other dynamic helipad illumination systems 2.

For example, the dynamic helipad illumination system 2 can alternatively or additionally have at least one illumination element 3 that is formed such that it can itself form an illuminated sign, e.g. an illuminated letter, number, cross, arrow, et cetera. Alternatively or additionally, at least one group of illumination elements can be formed such that the illumination elements of said group can together form a sign, e.g. a letter, number, cross, arrow, et cetera. Advantageously, at least one, and preferably each, of said illumination elements of said group can form a relatively large part of said sign. For example, said at least one, and preferably each, of the respective illumination elements of said at least one group can have a form differing from a pixel, i.e. a form not being shaped as a pixel. In embodiments, the dynamic helipad illumination system 2 and/or a helipad 1 provided with said system 2 may then function in a similar or equivalent manner as a variable message sign.

Besides, it is noted that the dynamic helipad illumination system 2 can be arranged such that at least one of the illumination elements 3 thereof, especially one of the illumination elements 3 in the array 5 or the matrix 5, can be switched independently of at least one other of the multiple illumination elements 3. The system 2 may then be arranged to control at least a part of the illumination elements 3, e.g. a part used to communicate a changeable or variable message to a pilot. Thereto, the at least one switchable illumination element 3 may be switchable between at least a first and a second state, wherein the light intensity and/or the color or wavelength of light emitted by said at least one switchable illumination element differs between its first state and its second state.

For example, the system 2 can be arranged such that the light intensity of the respective one or respective multiple illumination elements can be switched from a light intensity irradiating substantially no light to at least a perceptible light intensity. Said light intensity irradiating substantially no light may for instance correspond to an off-state of the respective illumination element 3. Alternatively or additionally, the light intensity can be switchable between at least one relatively low intensity and at least one relatively high intensity. For instance in a case wherein the respective changeable illumination elements 3 are part of a matrix 5 forming a display, a picture or image shown by said display and/or the visual appearance 41, 42 radiated by said display can be changed from one state into another when the light intensity of its pixels 3c can be changed.

It is noted that the color or the wavelength of the light emitted may preferably be a color or wavelength visible to the naked eye or so-called unaided eye. For example, the light of the switchable illumination element can be switched between a first visible color and at least a second visible color, e.g. from red to green to blue. Preferably, the light intensity of light emitted by an illumination element 3, e.g. corresponding to the brightness of a respective pixel, can be switched or controlled as well.

However, in embodiments, the light of at least one of the states of the switchable illumination element 3c may be of a color or wavelength invisible to the naked eye. For example, said illumination element can then be switched between an off-state in which it does not substantially illuminate any light and at least one on state in which it illuminates light not visible to the naked eye, but visible to an aided eye, e.g. ultraviolet or infrared light, such that a changed state of the illumination element can for instance be perceived by an aided eye and/or by means of an infrared light vision device, an ultraviolet vision light device, a night vision goggle (NVG), or another night vision device (NVD).

Alternatively or additionally, said illumination element 3c can be switched at least between a state in which it radiates visible light and a state in which it radiates non-visible light, such that said non-visible light radiation state can for instance be employed as an off-state of the illumination element.

In advantageous embodiments, the dynamic helipad illumination system 2 can comprise a controller or computer for controlling at least one of the illumination elements 3. The system 2 may be controlled at least partly based on information stored in said computer or controller, which, for instance thereto, may comprise a memory. Preferably, the system 2 or said controller can be programmable, e.g. by means of an input device.

It is noted that the dynamic helipad illumination system 2 can comprise and/or can be connected to a power supply and/or a power source for powering at least a part of the system 2, such as for instance at least a part of the illumination elements and/or the controller or computer. Additionally or alternatively, the system 2 may comprise an emergency or back-up power battery and/or an emergency power or stand-by unit. Providing the dynamic helipad illumination system 2 with an emergency power supply unit or an emergency power source can make said system 2 relatively reliable or fail-proof, which can be of great value, especially at an off-shore location and/or in a hazardous environment.

In embodiments, the system 2 can comprise one or multiple sensors for sensing one or multiple local conditions of, at and/or near the helipad 1 and/or for obtaining data relating to such condition(s). For instance, said local condition may relate to a wind direction and/or a wind speed or force. Preferably, the system 2 may be arranged to control one or multiple of the illumination elements 3 at least partly based on input provided by said one or multiple sensors, e.g. in order to radiate a visual appearance corresponding to at least a message communicating at least a part of the data relating to a respective local condition, in order to inform the helicopter crew or the pilot. This is, for example the wind direction and/or the wind force, sensed by one or more sensors, may then automatically be displayed by the dynamic helipad illumination system 2.

It is noted that said system 2 can alternatively or additionally be arranged to receive information from other sources. For example, the system 2, especially its controller or computer can be arranged to receive information from an external source, e.g. from a weather forecasting service and/or an air traffic control (ATC) service, e.g. via the internet and/or via satellites.

Furthermore, it is noted that the invention also relates to a helipad 1, wherein said helipad 1 comprises a dynamic helipad illumination system 2 according to the present invention. Said helipad 1 can preferably be located on an off-shore structure, such as an off-shore platform or a vessel. Advantageously, the helipad can be located on a platform, e.g. a drilling platform such as an oil rig or the like. The off-shore platform may be fixed to the ocean floor. However, the platform may alternatively form an artificial island or may float. During landing and/or taking off, said platform can preferably be at least temporarily fixed with respect to the ocean floor.

Especially in offshore environments, providing up to date information and/or information relating to current conditions may be of uttermost importance for facilitating a safe landing and/or take off. However, especially offshore, it may up to now be relatively hard to provide a pilot with such information in an easy and/or reliable manner. Therefore, especially offshore, the present invention can be very useful. Nevertheless, the helipad 1 and the helipad illumination system 2 according to aspects of the present invention, may be located on land, e.g. on a building or rooftop or at a heliport, and the use thereof may also on land be advantageous as well.

Moreover, the present invention relates to the use of a dynamic helipad illumination system 2. Said system 2 can for instance be used during landing or taking off, especially in order to provide a pilot or a helicopter crew with current and/or adequate information.

It is noted that for the purpose of clarity and a concise description features are described herein as part of the same or separate embodiments, however, it will be appreciated that the scope of the invention may include embodiments having combinations of all or some of the features described.

Further, it is noted that the invention is not restricted to the embodiments described herein. It will be understood that many variants are possible.

For example, the dynamic helipad illumination system can comprise a TLOF indication illumination 2b, e.g. in the form a circle, which illumination 2b can be arranged to illuminate a part of the helipad 1 in a substantially static manner. Inside and/or outside, especially around, said TLOF indication illumination 2b, a dynamic illumination can be provided, e.g. in the form of circle comprising one or multiple illumination elements, wherein said dynamic illumination can preferably be arranged to emit another color of light than said TLOF indication illumination 2b. By illuminating only a part of said dynamic illumination, a certain message may be radiated to a pilot. For example, a certain part of said dynamic illumination can be lid that corresponds to a certain wind direction. Said specific part of the dynamic illumination, which part is lid while other parts of said dynamic illumination are off, can then function as a pointer or indicator.

As another example, it is noted that the dynamic helipad illumination system may be specially arranged to be suitable to be used at a location having a potential hazardous environment, where for instance concentrations of flammable gases, vapors, or dusts may occur. The system may be intended and/or may be arranged for use in a hazardous area. In embodiments, the system may for instance be arranged not to produce sparks with sufficient energy to trigger an explosion. Hence, the dynamic helipad illumination system can for instance be safely used at a drilling rig or at another location, especially an off-shore location, being a potential hazardous location.

Such and other variants will be apparent for the person skilled in the art and are considered to lie within in the scope of the invention as formulated in the following claims

1. Dynamic helipad illumination system for dynamically illuminating a floor surface or supporting deck of a helipad at least partly in order to enable communication of information regarding one or more current local conditions of, at and/or near the helipad, the dynamic helipad illumination system comprising one or multiple illumination elements, wherein the dynamic helipad illumination system is arranged to bring at least a part of said one or multiple illumination elements from a first illumination state, in which at least a part of the floor surface or support deck of the helipad is at least partly illuminated by at least a number of said at least part of the one or multiple illumination elements such that at least a part of the floor surface or support deck radiates a first visual appearance which may correspond to at least a first message to be communicated to a helicopter crew or a pilot, into a second illumination state, in which at least a part of the floor surface or support deck of the helipad is at least partly illuminated by at least a number of said at least part of the one or multiple illumination elements such that at least a part of the floor surface or support deck of the helipad radiates a second visual appearance which may correspond to at least a second message to be communicated to the helicopter crew or the pilot, wherein said first visual appearance differs from said second visual appearance.

2. Dynamic helipad illumination system according to claim 1, wherein multiple illumination elements of the system together form an array or a matrix suitable for displaying information regarding one or more current local conditions of, at and/or near the helipad, preferably wherein a multiple number of the illumination elements can form pixels in the array or the matrix, more preferably pixels being switchable and/or controllable independently of each other.

3. Dynamic helipad illumination system according to claim 2, wherein the array or matrix is part of the floor surface or support deck of the helipad.

4. Dynamic helipad illumination system according to claim 2, wherein the array or matrix can function as a monitor, picture screen or so called visual display unit (VDU), such that said array or matrix may for instance display images, e.g. including one or more arrows, letters, and/or numbers etc., which are build up from multiple ones of said pixels.

5. Dynamic helipad illumination system according to claim 1, wherein one or multiple illumination elements, especially illumination elements forming pixels in the array or the matrix, are formed as a light emitting element protected by a cover, especially a dome.

6. Dynamic helipad illumination system according to claim 5, wherein the cover is arranged for substantially evenly distributing light from the light emitting element, preferably one or more LEDs, across at least a part of the surface area of said cover, for example at least partly due to a frosted or matted cover surface or cover layer of said cover.

7. Dynamic helipad illumination system according to claim 2, wherein multiple illumination elements forming pixels in the array or the matrix are mounted on top of a top surface of the deck or floor of the helipad.

8. Dynamic helipad illumination system according to claim 1, wherein at least one illumination element is formed such that itself can form an illuminated sign, e.g. an illuminated letter, number, cross, arrow, et cetera.

9. Dynamic helipad illumination system according to claim 1, wherein at least one group of illumination elements is formed such that the illumination elements of said group can together form a sign, e.g. a letter, number, cross, arrow, etc., wherein at least one, and preferably each, of said illumination elements of said group forms a relatively large part of said sign, especially wherein said at least one, and preferably each, of said illumination elements of said at least one group has a form differing from a pixel, i.e. a form not being formed as a pixel.

10. Dynamic helipad illumination system according to claim 1, wherein at least one of the illumination elements, especially one of the illumination elements in the array or the matrix, can be switched independently of at least one other of the multiple illumination elements.

11. Dynamic helipad illumination system according to claim 10, wherein the at least one switchable illumination element is switchable between at least a first and a second state, wherein the color or wavelength of light emitted by said at least one switchable illumination element differs between its first state and its second state.

12. Dynamic helipad illumination system according to claim 10, wherein the at least one switchable illumination element is switchable between at least a first and a second state, wherein the light intensity of light emitted by said at least one switchable illumination element differs between its first state and its second state.

13. Dynamic helipad illumination system according to claim 12, wherein the light intensity of the respective one or respective multiple illumination elements can switch from a light intensity irradiating substantially no light to at least a perceptible light intensity.

14. Dynamic helipad illumination system according to claim 1, wherein at least a part of the illumination elements are arranged to form:
a TLOF indication illumination for marking the touchdown and lift-off area (TLOF), e.g. formed as a TLOF perimeter indication illumination for marking a perimeter of the TLOF;
an ‘H’ shaped illumination, preferably an ‘H’ enclosed by said TLOF perimeter indication illumination; and/or
a FATO indication illumination for marking the final approach and takeoff area (FATO), e.g. formed as a FATO perimeter indication illumination for marking a perimeter of the FATO.

15. Dynamic helipad illumination system according to claim 1, wherein at least a part of the illumination elements are arranged to form an illumination portion for at least partly illuminating another part of the helipad than the parts to be illuminated by the TLOF indication illumination, especially formed by a TLOF perimeter indication illumination, the ‘H’ shaped illumination or the FATO indication illumination, especially formed by a FATO perimeter indication illumination.

16. Dynamic helipad illumination system according to claim 1, wherein at least a number of the illumination elements, especially at least a part of at least one array or matrix of illumination elements, is located outside the TLOF, preferably located outside the TLOF but within the FATO.

17. Dynamic helipad illumination system according to claim 1, further comprising a controller for controlling at least one of the illumination elements.

18. Dynamic helipad illumination system according to claim 1, further comprising one or multiple sensors for sensing one or multiple local conditions of, at and/or near the helipad, such as for instance a wind direction and/or a wind speed, wherein the system is arranged to control one or multiple of the illumination elements at least partly based on input or data provided by said one or multiple sensors, e.g. in order to radiate a visual appearance at least corresponding to a message communicating at least a part of the data relating to a respective local condition to the helicopter crew or the pilot.

19. Dynamic helipad illumination system according to claim 1, wherein said is system is for use in a hazardous area.

20. Off-shore helipad, comprising a supporting deck or floor surface for supporting a helicopter, wherein said supporting deck or floor surface is provided with a helipad illumination system for illuminating at least a part of said supporting deck or floor surface, characterized in that illumination system is a dynamic system for dynamically illuminating at least a part or parts of the helipad supporting deck or floor surface in order to enable communication of information regarding one or more current local conditions of, at and/or near the helipad, wherein the dynamic helipad illumination system comprises one or multiple illumination elements and the system is arranged to bring at least a part of said one or multiple illumination elements from a first illumination state, in which at least a part of the floor surface or support deck of the helipad is at least partly illuminated by at least a number of said at least part of the one or multiple illumination elements such that said at least part of the floor surface or support deck radiates a first visual appearance which may correspond to at least a first message to be communicated to a helicopter crew or a pilot, into a second illumination state, in which at least a part of the floor surface or support deck of the helipad is at least partly illuminated by at least a number of said at least part of the one or multiple illumination elements such that at least a part of the floor surface or support deck of the helipad radiates a second visual appearance which may correspond to at least a second message to be communicated to the helicopter crew or the pilot, wherein said first visual appearance differs from said second visual appearance.

21. Helipad, for instance located on an off-shore structure, such as an off-shore platform or vessel, wherein said helipad comprises a dynamic helipad illumination system according to claim 1.

22. Use of a dynamic helipad illumination system according to claim 1 during landing or taking off.
